(19) United States
(12) Patent Application Publication
(10) Pub. No.: US 2025/0388272 A1
(43) Pub. Date: Dec. 25, 2025

(54) VEHICLE TAILGATE WITH FOLD-UP FENCE

(71) Applicant: Makai Technologies Inc., Dover, DE (US)

(72) Inventor: Erich Kai Stephan, San Rafael, CA (US)

(21) Appl. No.: 19/244,996

(22) Filed: Jun. 20, 2025

Related U.S. Application Data
(60) Provisional application No. 63/662,380, filed on Jun. 20, 2024.

(51) Int. Cl. B62D 33/027; B62D 33/03

(52) U.S. Cl. CPC B62D 33/0273; B62D 33/03; B62D 33/08

(57) ABSTRACT

Embodiments of the present invention may include a vehicle tailgate assembly comprising a tailgate with an inside wall, a top edge orthogonal to the inside wall, and a cavity having an opening in the top edge. The assembly may further comprise of a fence mounted to the tailgate in a slidable and pivotal manner between a stowed state and a deployed state. Embodiments of the present invention may further include a method of loading cargo onto a vehicle bed with a tailgate. The method may include lowering the tailgate to a horizontal position, loading the cargo into the vehicle bed, sliding the main fence out of the cavity, rotating the at least one side fence to an at least orthogonal position relative to the main fence, pivoting the main fence about a main fence hinge axis, and locking the at least one side fence to the tailgate.

### CROSS-REFERENCE TO RELATED APPLICATIONS

The present patent application claims the priority benefit of U.S. provisional patent application 63/662,380 filed Jun. 20, 2024, the disclosures of which are incorporated by reference herein.

### BACKGROUND OF THE INVENTION

Currently, tailgate apparatus on vehicles fold from an upright to a horizontal position in order to load various cargo. Sometimes the cargo may extend from the bed of the vehicle and onto the tailgate, preventing the tailgate from closing back to a vertical position thereby compromising the security of the cargo from staying the vehicle during transit. The present invention allows for a barrier to extend out from a tailgate when the tailgate is in a down position, wherein the barrier rotates up to a vertical position to prevent the cargo from sliding out from the back of the vehicle.

### SUMMARY OF THE CLAIMED INVENTION

Embodiments of the present invention may include a vehicle tailgate assembly comprising a tailgate with an inside wall, a top edge orthogonal to the inside wall, and a cavity having an opening in the top edge. The assembly may further comprise of a fence mounted to the tailgate in a slidable and pivotal manner between a stowed state and a deployed state. The fence may include a main fence and one or more side fences.

Embodiments of the present invention may further include a method of loading cargo onto a vehicle bed with a tailgate. The method may include lowering the tailgate to a horizontal position, the tailgate having an inside surface, a cavity, a main fence within the cavity, and at least one side fence rotatably connected to the main fence. The method may further include loading the cargo into the vehicle bed such that the cargo extends onto the inside surface of the tailgate, sliding the main fence out of the cavity, rotating the at least one side fence to an at least orthogonal position relative to the main fence, pivoting the main fence about a main fence hinge axis to an orthogonal position relative to the inside surface of the tailgate; and locking the at least one side fence to the tailgate, wherein the at least one side fence is releasably locked to the tailgate.

### BRIEF DESCRIPTION OF THE DRAWINGS

FIG. 1 is an isometric view of a tailgate and fence in a stowed state.

FIG. 2 is a side sectioned view of a tailgate depicting a fence stowed in a cavity.

FIG. 3 is an isometric view of a slide track with a fence traversed out of a cavity in a tailgate, with the tailgate hidden.

FIGS. 4A and 4B are isometric and side section views, respectively, of a fence partially traversed out of a cavity in a tailgate.

FIGS. 4C and 4D are isometric and side section views, respectively, of a fence fully traversed out of a cavity in a tailgate.

FIGS. 5A through 5E are isometric views of a fence rotating about a hinge axis, with at least one side fence pivoting about a side fence hinge axis and locking to a tailgate.

FIGS. 6A and 6B are close up isometric views of a side fence locking to a tailgate.

FIGS. 7A through 7C are isometric views of a fence with a hinge slot connection traversing out of a cavity in a tailgate.

FIGS. 8A through 8E depict isometric views of a potential method to deploy a fence out of a tailgate after cargo is loaded into a vehicle bed.

FIGS. 9A through 9E depict isometric views of an alternative embodiment where the fence locks to the tailgate with at least one arm.

FIGS. 10A through 10K depict various views of an alternative embodiment where at least one side fence traverses laterally from a main fence before pivoting about a side fence hinge.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

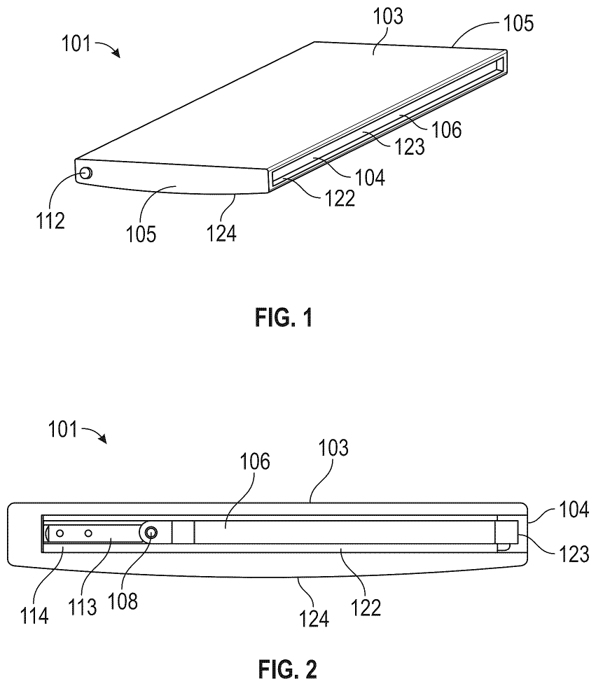

FIG. 1 depicts an isometric view of tailgate 101 with vehicle 100 hidden for ease of description, representing one example embodiment of the present invention. Tailgate 101 may have two tailgate side edges 105 connected by a tailgate inside wall 103. On a first end of a tailgate side edge 105, a tailgate hinge point 112 may be positioned and configured to cooperate with a corresponding axis point on a vehicle 100. In some example embodiments not shown, tailgate hinge points 112 may pivotally connect to a hinge point on a vehicle 100, or to a linkage that is then directly or pivotally connected to a vehicle 100. Tailgate top edge 104 may be orthogonal to tailgate inside wall 103 and also span between a first tailgate side edge 105 and a second tailgate side edge 105, as depicted. Tailgate top edge 104 may be on the opposite side of tailgate 101 from tailgate hinge point 112, as depicted, such that tailgate top edge 104 may be the furthest surface from the pivotal axis of tailgate hinge point 112 or to the pivotal engagement of tailgate 101 to vehicle 100. One or more tailgate cavity 122 may reside within tailgate 101, and in some embodiments, tailgate cavity 122 may span from substantially one side of tailgate 101 to a far side of tailgate 101, as shown. In other example embodiments, tailgate cavity 122 may be bifurcated along a mid-plane substantially parallel to tailgate side edge 105, thus creating two tailgate cavities 122.

Main fence 106 may be configured to slidably occupy tailgate cavity 122 when main fence 106 is in a stowed state, as depicted in FIGS. 1 and 2. Fence top edge 123 may coincide with tailgate top edge 104 when main fence 106 is stowed, and fence top edge 123 may form a watertight seal with tailgate top edge 104. In other example embodiments, fence top edge 123 may form a seal with tailgate top edge 104 tight enough to prevent ingress of debris, such as a perimeter gap between fence top edge 123 and tailgate top edge 104 on all four sides of 0.5-2.0 millimeters. In other examples, fence top edge 123 may have a flange or plate that substantially covers tailgate top edge 104 and that extends nearly to, exactly to, or slightly beyond tailgate inside wall 103 and tailgate outside wall 124.

FIG. 2 depicts a side cut-away view of tailgate 101 exposing the inside of tailgate cavity 122, representing one example embodiment of the present invention. As depicted, main fence 106 occupies the space within tailgate cavity 122. Opposite from fence top edge 123, main fence 106 may be pivotally connected to one or more fence slide cars 113 via fence hinge 108. Fence slide car 113 may be connected fence slide track 114 with one or more bearings, wheels, slides, low-friction surfaces, or other suitable means to allow fence slide car 113 from traversing along the length of fence slide track 114.

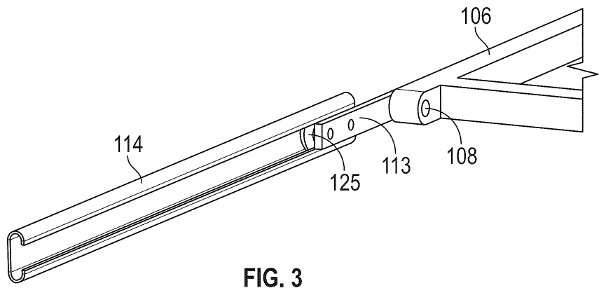

FIG. 3 is an isometric view of main fence 106 extended out of fence slide track 114 with tailgate 101 hidden for clarity, representing one example embodiment of the present invention. In this example embodiment, fence slide car 113 has traversed the length of fence slide track 114 relative to the position shown in FIG. 2. One or more slide car bearings 125 may be connected to fence slide car 113 to allow fence slide car 113 to readily traverse fence slide track 114 with minimal friction. Fence slide track 114 may be configured to capture one or more slide car bearings 125 in a way to substantially prevent slide car bearing 125 from traversing or rotating or yawing in a direction or angle other than along the length of fence slide track 114. In some cases, slide car bearing 125 may be a separate component attached to fence slide car 113, such as a wheel or ball bearing, or slide car bearing 125 may be an incorporated feature in fence slide car 113, such as a flange or permanently fixed component.

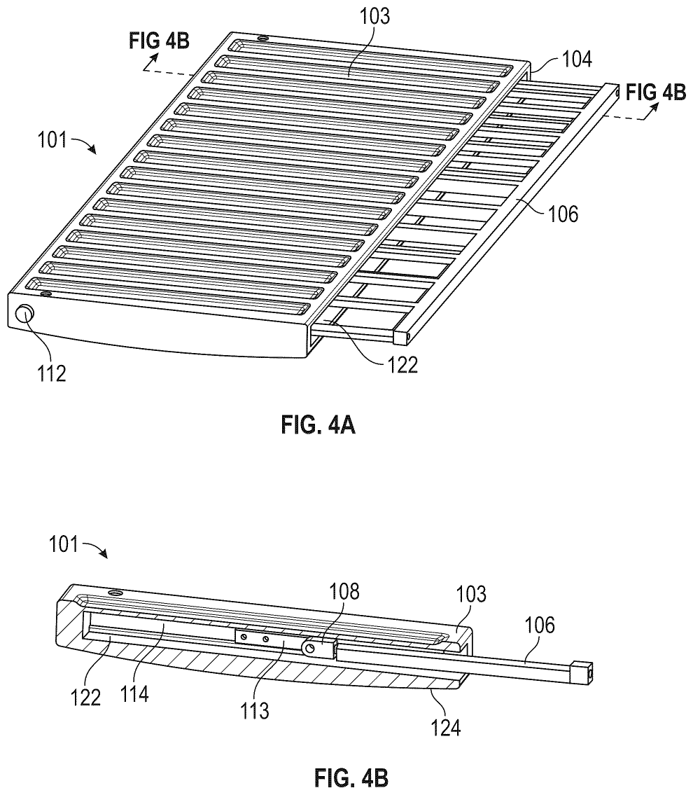

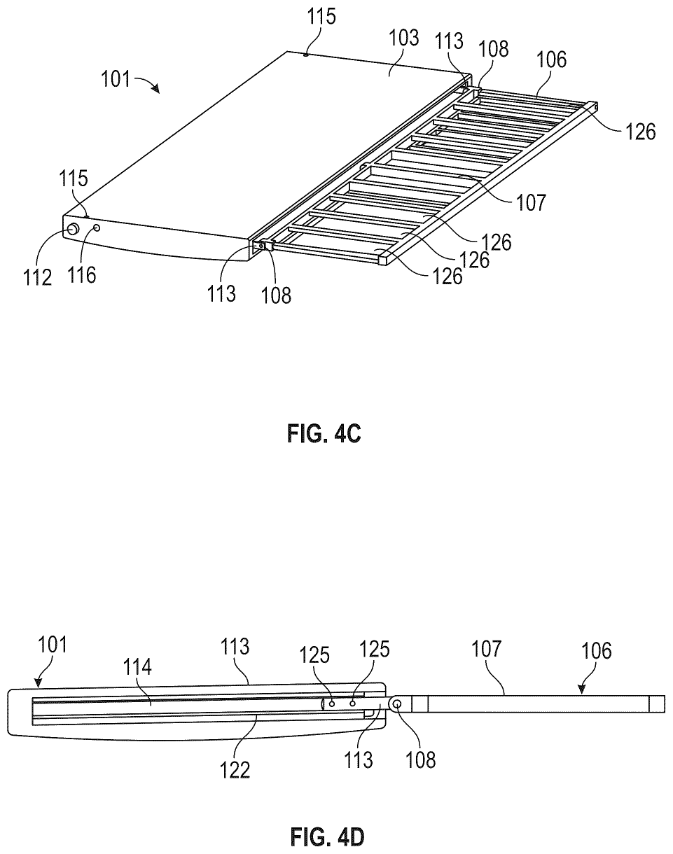

FIGS. 4A and 4B depict isometric and side cut-away views of main fence 106 in a partially traversed position. Main fence 106 has partially traversed out of tailgate cavity 122 by potentially sliding along at least one slide track 114. FIG. 4B is a section view FIG. 4A depicting the inside of tailgate 101, thus revealing slide track 114 on an inside surface of tailgate cavity 122. Slide car 113 is partially traversed in a slidable motion along the length of slide track 114, thereby traversing main fence 106 also out of tailgate cavity 122.

FIGS. 4C and 4D depict isometric and side cut-away views of main fence 106 traversed position, representing one example embodiment of the present invention. As shown, main fence 106 has laterally traversed out of tailgate cavity 122. In this example, fence hinge 108 has also traversed beyond tailgate top edge 104. Fence slide car 113 may be configured to position fence hinge 108 beyond tailgate top edge 104 while slide car bearing 125 is retained by fence slide track 114. Fence slide track 114 may extend the full or partial length of tailgate cavity 122. Fence slide track 114 may have one or more stop features to prevent slide car bearing 125 from traversing out of the end of fence slide track 114, such as a crimped end, interference pin, screw, boss, notch, stake, or similar feature. Not shown, one or more actuators or dampeners may be connected to fence slide car 113 and tailgate 101 in order to control the traversal action of fence slide car 113 along fence slide track 114.

Main fence 106 may have fence wall 107 configured as a plurality of bars as shown, or may be configured as a flat plate, lattice, hexagonal pattern, or combination thereof. Fence wall 107 may be configured with a plurality of fence apertures 126. Fence apertures 126 may be configured to readily prevent large items from sliding out of vehicle bed 102 (shown in later figures). In some cases, fence wall 107 may have a solid surface extending partially from the side nearest tailgate 101 towards main fence 106, such as 4 to 6 inches, and then one or more fence apertures 126 disposed on an upper section of fence wall 107. Fence apertures 126 may be configured to allow airflow for improved aerodynamics of vehicle 100.

Main fence 106 and one or more side fences 117 may be made from steel, aluminum, polymer, or combination thereof. Main fence 106 may be coated to prevent corrosion, or to match the color scheme of tailgate 101 or vehicle 100.

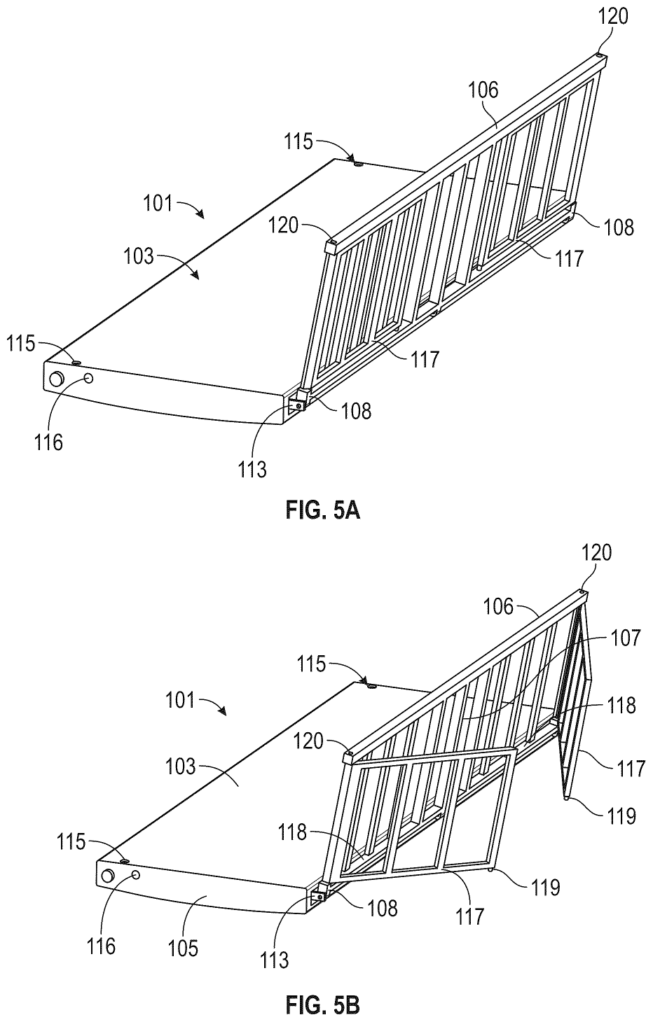

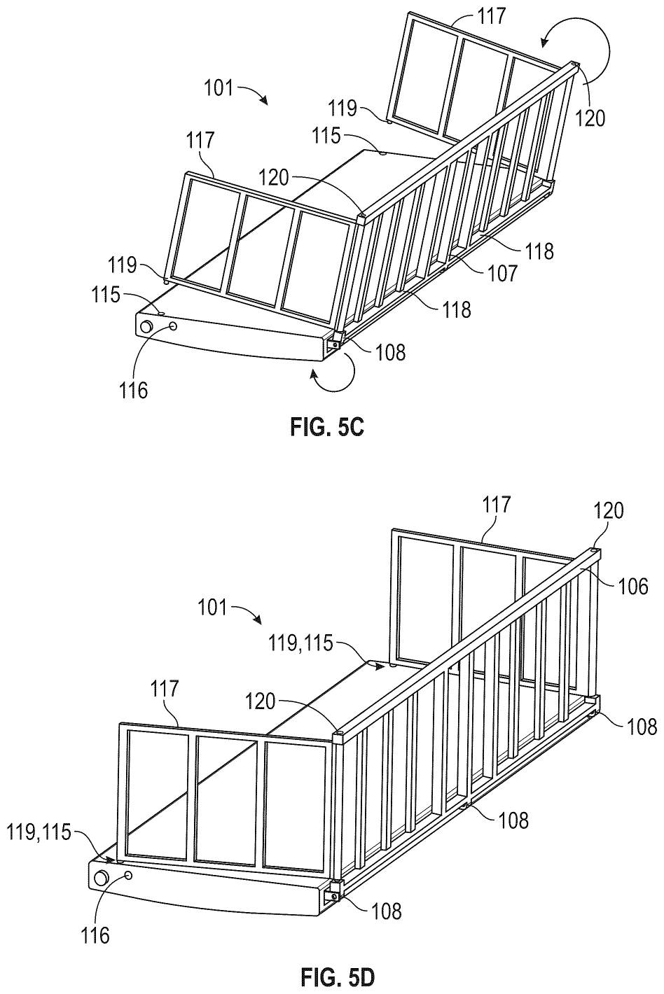

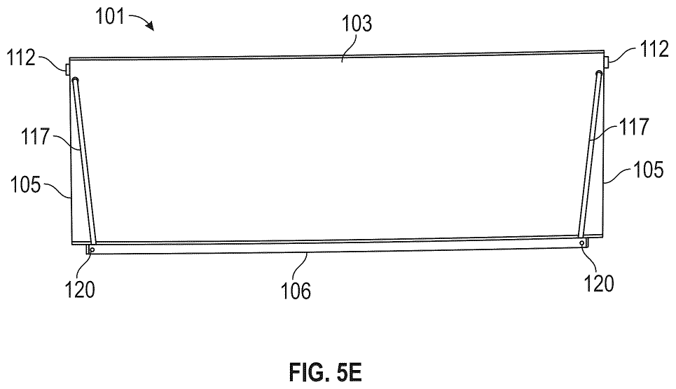

FIGS. 5A through 5D depict isometric views of main fence 106 articulating from a traversed position to a vertical locked position with one or more side fences 117 deployed, representing one example embodiment of the present invention. In FIG. 4A, main fence 106 has pivotally articulated about the axis of one or more fence hinge 108 from a traversed position to an obtuse angle relative to tailgate inside wall 103. As shown, one or more side fences 117 may be pivotally connected to main fence 106 at side fence axis 120. Side fence 117 and main fence 106 may be configured to allow side fence 117 to nest withing the thickness of main fence 106 inside fence recess 118. In this example, side fence recess 118 is on a back side of main fence 106, but in other examples, side fence recess 118 may be on a front side of main fence 106 (facing towards tailgate inside wall 103 when main fence 106 is stowed inside tailgate cavity 122).

In FIG. 5B, one or more side fences 117 are partially articulated about the axis of a respective side fence axis 120. In this example embodiment, side fence 117 rotates away from vehicle 100 when being deployed from a side fence recess 118, but in other example embodiments where side fence recess 118 is on a front side of main fence 106, one or more side fences 117 may rotate towards vehicle 100 when being deployed. One or more fence locks 115 may be disposed on tailgate inside wall 103 and configured to receive a respective one or more fence lock flanges 119 disposed on a distal end of side fence 117. In other example embodiments, fence lock flanges 119 may be at a mid-point alongside fence 117 closer to the side of side fence axis 120. Fence lock release 116 may be disposed on tailgate side edge 105 as shown, or on tailgate inside wall 103, side fence 117, main fence 106, or elsewhere on tailgate 101 or vehicle 100.

In FIG. 5C, one or more side fences 117 have articulated about the axis of side fence axis 120 so that a first fence lock flange 119 substantially aligns with a first fence lock 115 and a second fence lock flange 119 substantially aligns with a second fence lock 115. Main fence 106 may be at a low obtuse angle relative to tailgate inside wall 103 in order to aid in the alignment of the respective fence lock flange 119 to fence lock 115. In FIG. 5D, a first fence lock flange 119 has engaged with a first fence lock 115, and a second fence lock flange 119 has engaged with a second fence lock 115, which may substantially prevent the rotation of main fence 106 about the axis of one or more fence hinge 108. Main fence 106 is now in a deployed state. Main fence 106 and one or more side fences 117 may be substantially orthogonal to tailgate inside wall 103.

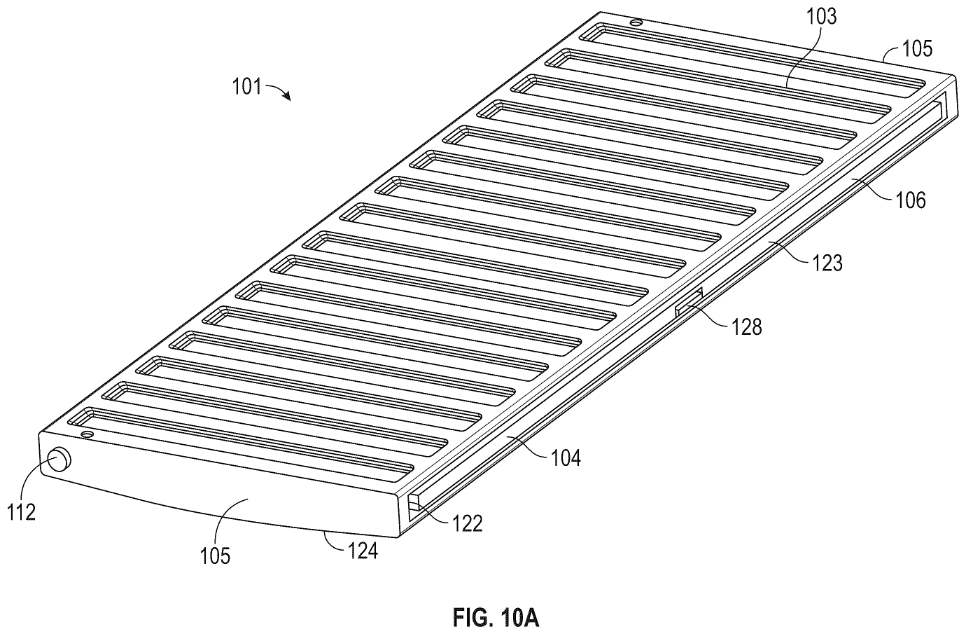

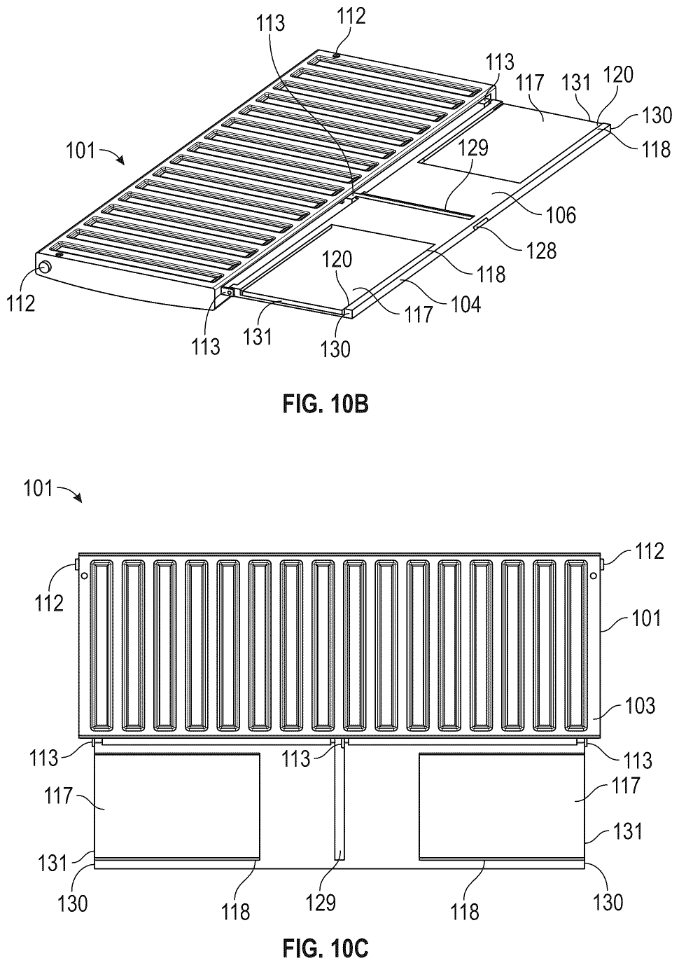

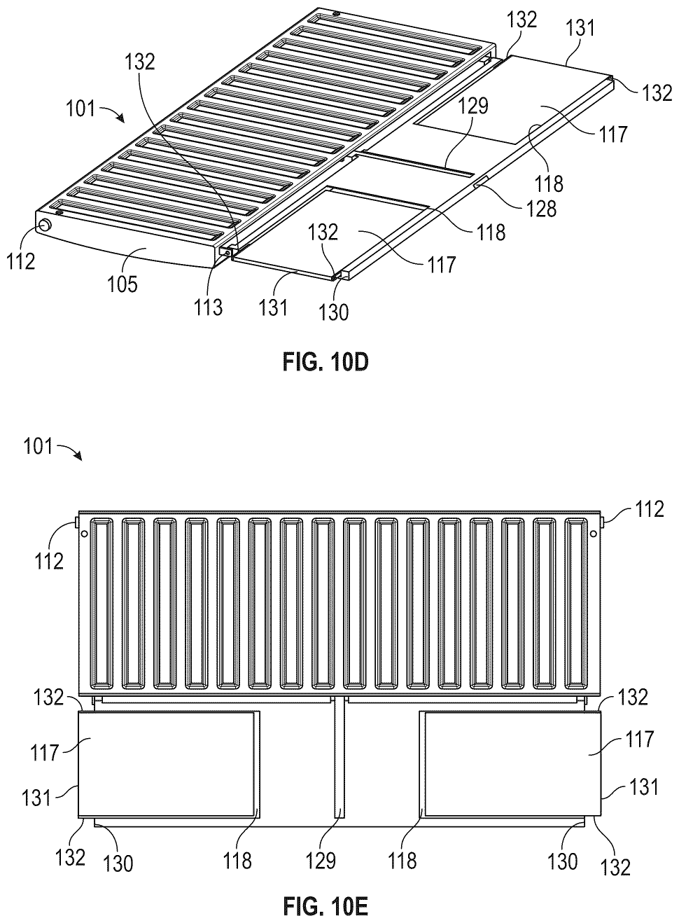

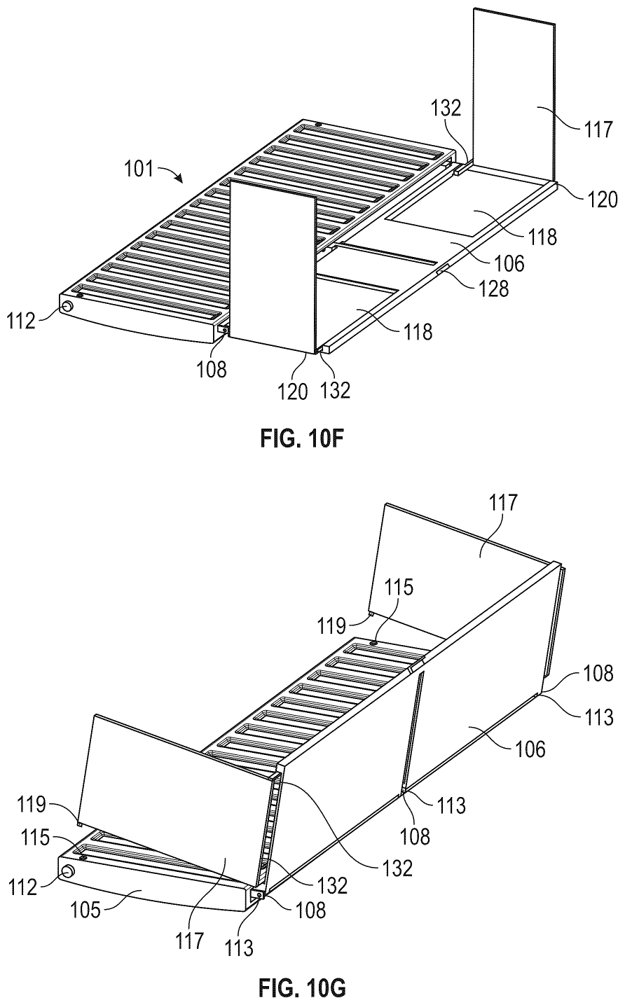

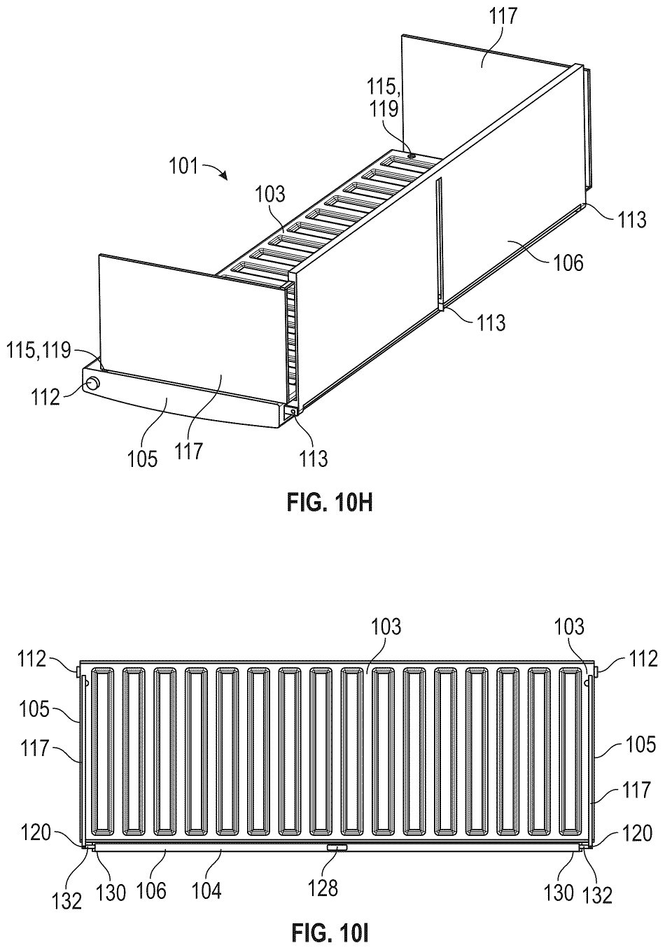

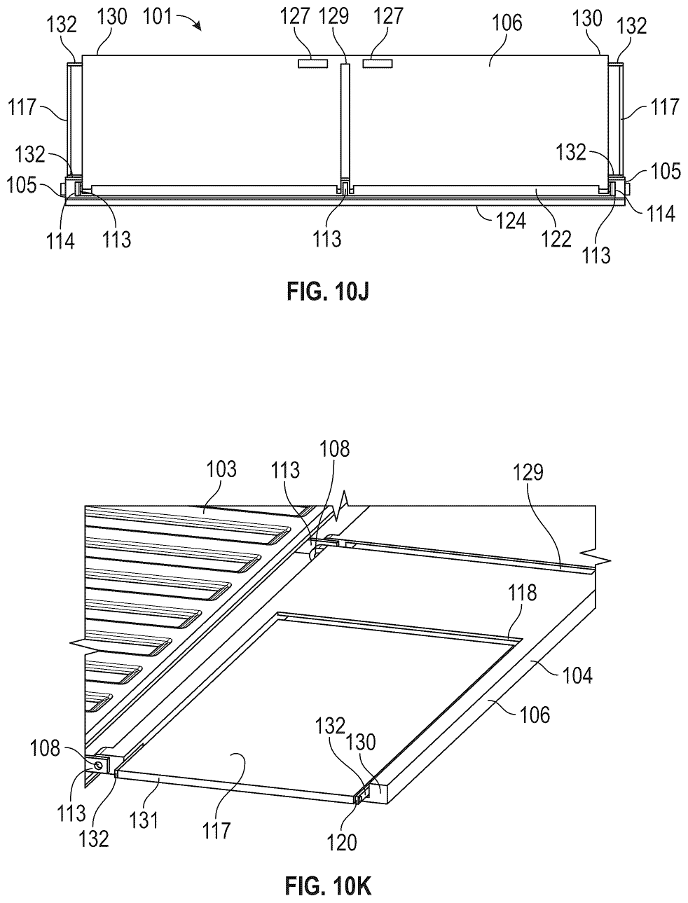

FIG. 5E depicts a top-down view of main fence 106 in a deployed state. As depicted, a first and second side fence 117 may not be parallel and may form an obtuse angle with main fence 106, or an angle at least orthogonal (as shown in FIG. 10I). In other examples, side fence 117 may extend beyond the end of tailgate inside wall 103 and connect directly to vehicle bed 102 or a side wall of vehicle 100. In yet other examples, side fence 117 may have one or more telescoping arms configured to connect side fence 117 to vehicle bed 102 or vehicle 100, which may negate a fence lock flange 119, or fence lock flange 119 may be disposed on the telescoping arm.

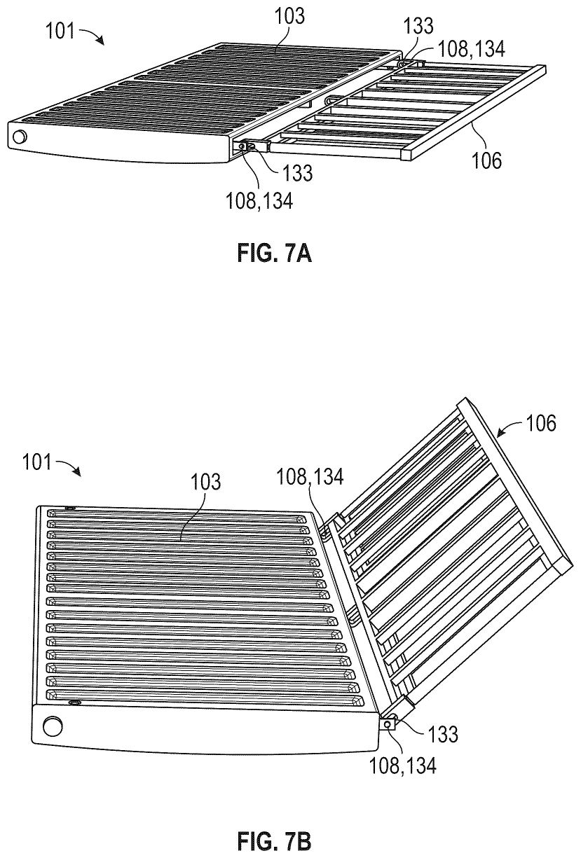

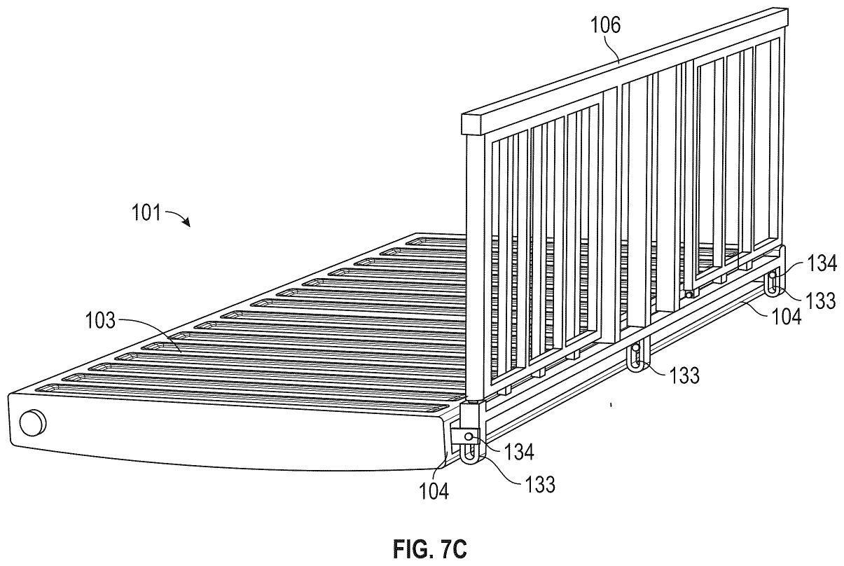

FIGS. 7A through 7C depict an isometric view of main fence 106 where the connection aperture in main fence 106 at fence hinge 108 may be a hinge slot 133 parallel to fence wall 107. FIGS. 7A and 7B depict main fence 106 in a parallel position and partially pivoted about fence hinge 108 to an obtuse position relative to tailgate inside wall 103. A pin 134 or flange connecting a fence slide car 113 to main fence 106 may allow for main fence 106 to rotate about the axis of one end of the hinge slot 133 until main fence 106 is in a substantially orthogonal position to tailgate inside wall 103, at which point main fence 106 may traverse in a vertical manner down so the pin 134 traverses the length of the hinge slot 133, as shown in FIG. 7C. In this way, a surface on main fence 106 beyond the hinge slot 133 may abut tailgate top edge 104 or another surface on fence slide car 113 or tailgate 101 that prevents main fence 106 from readily rotating away from orthogonal to tailgate inside wall 103. To rotate main fence 106 into a stowed state, main fence 106 may be lifted vertically so the pin 134 traverses back to the far distal end of the hinge slot 133, removing the abutment of the far surfaces on the far end of hinge slot 133, and allowing main fence 106 to then freely rotate from a substantially vertical state to an obtuse angle or parallel position relative to tailgate inside wall 103.

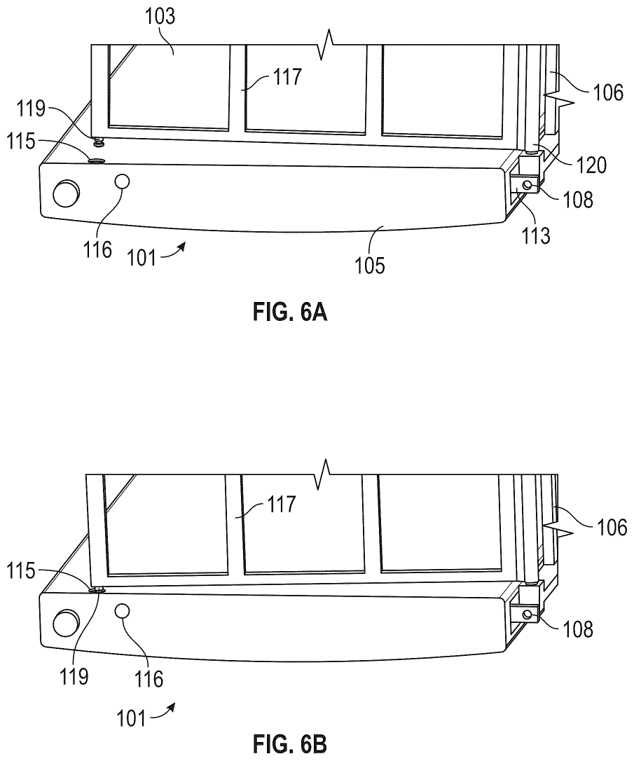

FIGS. 6A and 6B depict a close-up view showing the sequence described in FIGS. 5C and 5D, respectively. In this example embodiment, fence lock release 116 may be a depressible button that engages a locking flange inside fence lock 115. Fence lock flange 119 may be configured with a chamfered tip to more easily align with the opening of fence lock 115. Fence lock flange 119 may have one or more grooves or notches disposed on its surface and configured to engage with a locking flange within fence lock 115. Fence lock release 116 may mechanically or electronically traverse a locking flange within fence lock 115 to release fence lock flange 119 in order to decouple side fence 117 from tailgate 101 or vehicle 100. In some example embodiments, fence lock release 116 may control more than one fence lock 115 and may be located on side fence 117. In some cases, fence lock flange 119 may have a traversable or rotatable locking flange the engages with a groove or notch disposed in fence lock 115.

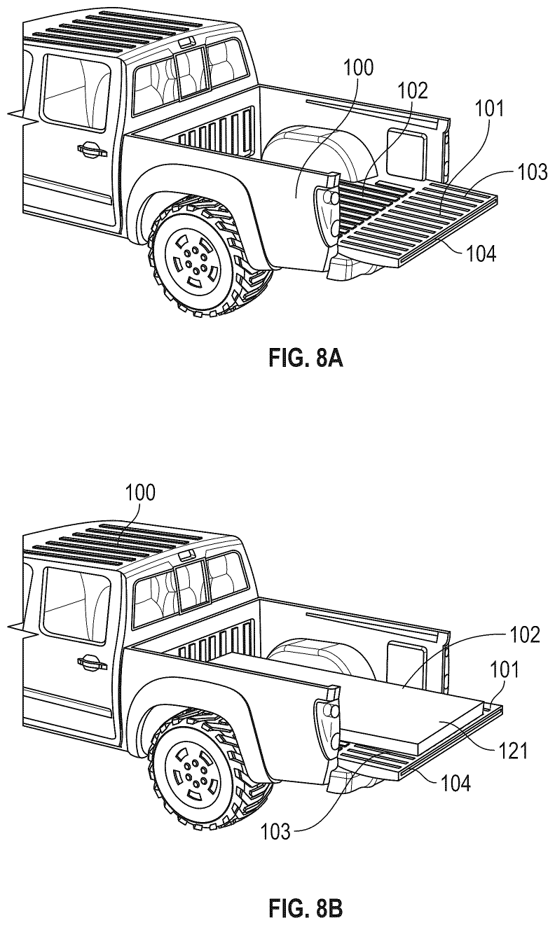

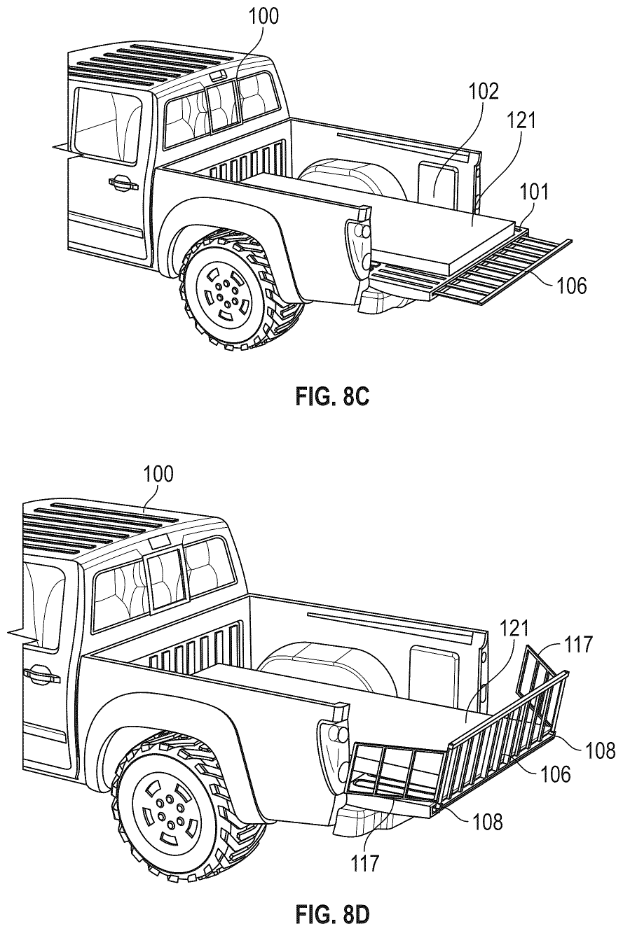

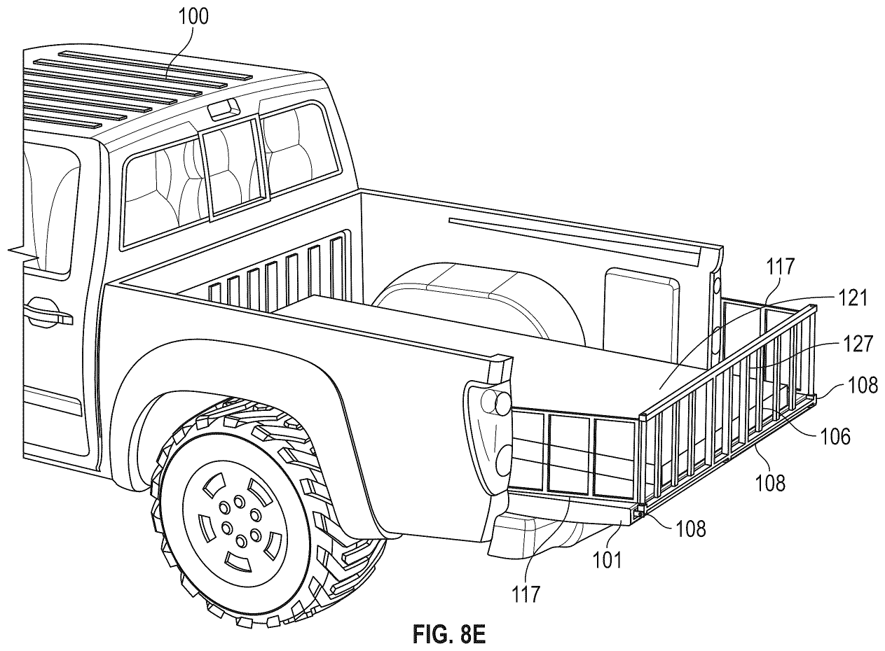

FIGS. 8A through 8E depict a sequence of transitioning a main fence 106 from a stowed state to a deployed state, representing one example embodiment of the present invention. In FIG. 8A, tailgate 101 is pivotally attached to vehicle 100, and has substantially the same color coating applied to at least tailgate outside wall 124. Tailgate 101 has been rotated about tailgate hinge point 112 into a lowered position, so that tailgate inside wall 103 is substantially planar to the bottom surface of vehicle bed 102.

FIG. 8B depicts the addition of cargo 121 into vehicle bed 102 and extending beyond the end of vehicle bed 102 and over tailgate inside wall 103. In this example, tailgate inside wall 103 is planar with vehicle bed 102 so that cargo 121 is substantially evenly supported by both tailgate inside wall 103 and vehicle bed 102.

FIG. 8C depicts main fence 106 traversing laterally out of tailgate cavity 122 away from vehicle 100. FIG. 8D depicts main fence 106 rotating about the axis of one or more fence hinges 108 to an obtuse angle with tailgate inside wall 103, and one or more side fences 117 rotating about the axis of one or more side fence axis 120. As shown, when cargo 121 extends up to tailgate top edge 104, there is no interference with main fence 106 during the motion of traversing main fence 106 out of tailgate cavity 122 and then rotating main fence 106 about fence hinge 108 to a substantially orthogonal position to tailgate inside wall 103. FIG. 6E depicts main fence 106 and one or more side fence 117 in a fully deployed state, where side fence 117 may be releasably locked to tailgate 101 or vehicle 100 to prevent main fence 106 from rotating about the axis of fence hinge 108. When one or more fence lock flange 119 are releasably locked to one or more respective fence locks 115, cargo 121 may be prevented from forcing main fence 106 or one or more side fences 117 from substantially rotating or traversing about any of their pivot or traversal points or interconnections. One or more fence illumination devices 127 may be disposed on a surface of main fence 106 and face away from vehicle 100. Fence illumination device 127 may be electrically connected and coordinated to illuminate when the brakes of vehicle 100 are engaged, or when brake lights of vehicle 100 are illuminated. Fence illumination device 127 may illuminate a red light when the brakes of vehicle 100 are engaged or illuminate white light when the transmission or configuration of vehicle 100 is put into reverse, or when vehicle 100 moves in a direction where fence illumination device 127 is at the front of movement.

Side fence 117 may be configured with one or more apertures disposed in its surface. Side fence 117 may be configured to prevent large objects from traversing through, such as a 2×4 beam. One or more mesh covers may be configured to connect onto a fence wall 107 and or one or more side fences 117 in order to prevent small cargo 121 from traversing through or beyond main fence 106. The distance between a first side fence 117 and a second side fence 117 along a main fence 106 (for example, the distance from a first side fence axis 120 to a second side fence axis 120), may be greater than 48 inches. Vehicle bed 102, tailgate 101, main fence 106, and up to two side fence 117 may be configured so that when the entire system is in a deployed state, such as depicted in FIG. 8E, a cargo 121 with horizontal dimensions of at least 48 inches by 96 inches will rest on vehicle bed 102 and tailgate inside wall 103 without interference with main fence 106 or side fences 117. As an example, cargo 121 in FIG. 8E depicts several wood sheets of 48 by 96 inches in horizontal dimension resting inside the space defined by vehicle bed 102 and the inside wall of main fence 106. Main fence 106 may be made to a suitable strength to prevent one or more cargo 121 from yielding or rupturing any party of main fence 106 or one or more side fences 117 during a vehicle collision or extreme acceleration event.

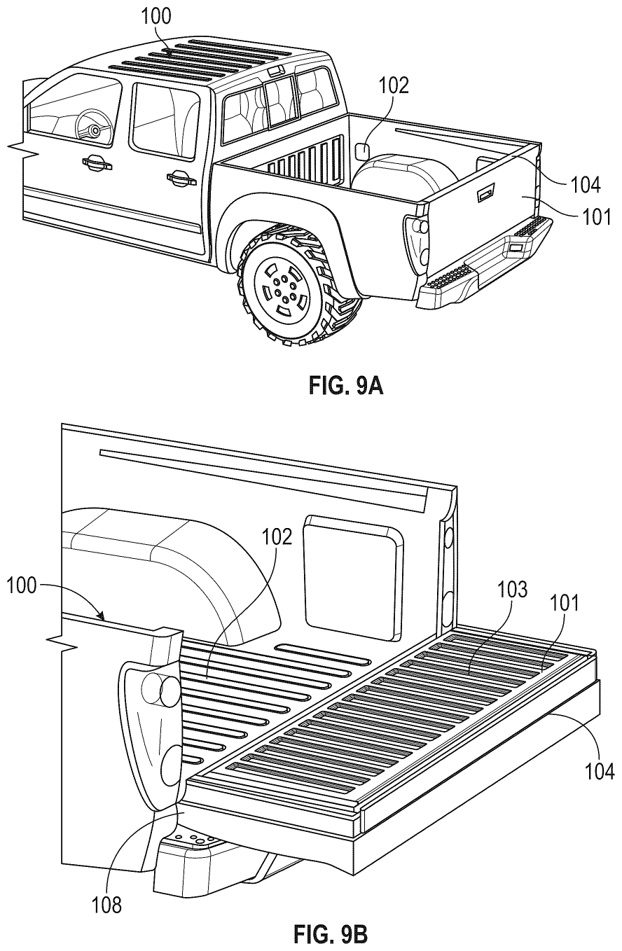

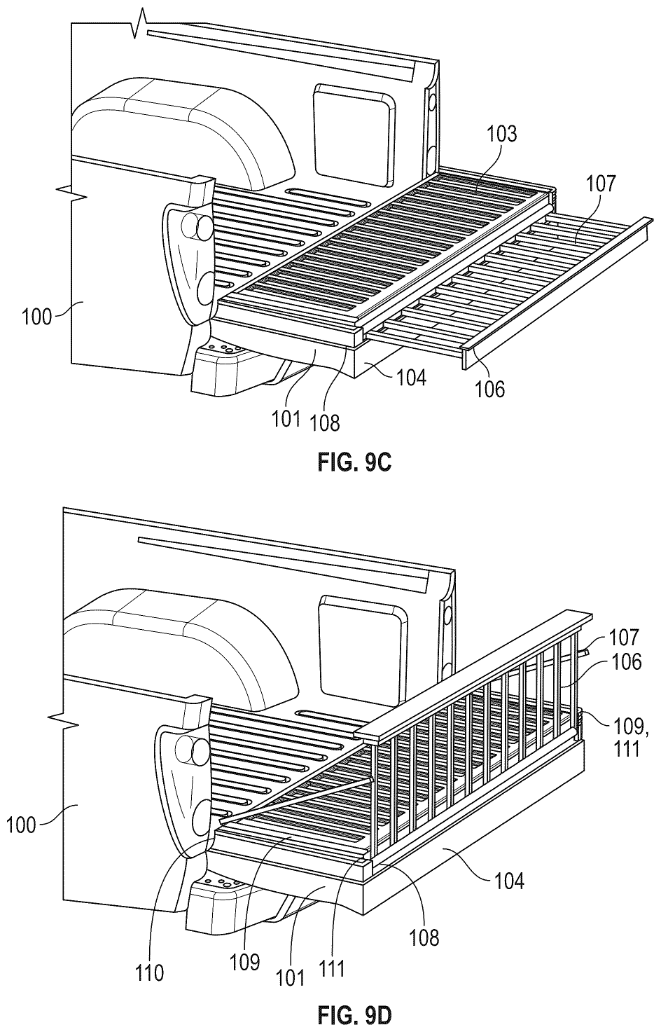

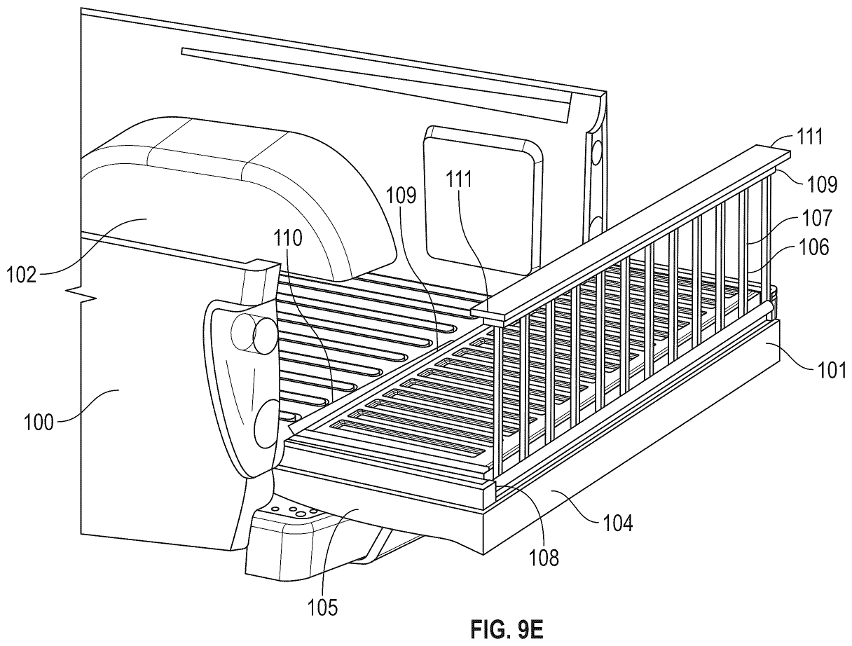

Depicted in the sequence of FIGS. 8A through 8E is a potential method of transition of a tailgate 101 and main fence 106 system from a stowed state to a deployed state. Not shown, tailgate 101 may be in a closed position (as seen in FIG. 9A), where tailgate inside wall 103 is substantially orthogonal to vehicle bed 102. In a possible next step, tailgate 101 may be released and lowered to an open position where tailgate inside wall 103 may be substantially planar with vehicle bed 102. In a possible next step, main fence 106 may be extended out of tailgate cavity 122, and then rotated up so fence wall 107 is at an obtuse angle with tailgate inside wall 103. In a possible next step, one or more side fence 117 may fold, rotate, bend, or otherwise traverse so that one or more fence lock flanges 119 are substantially aligned with a respective one or more fence locks 115. In a possible next step, fence lock flange 119 may releasably engage with fence lock 115 to secure main fence 106 and one or more side fence 117.

FIGS. 9A through 9E depict isometric views of a tailgate 101 system that uses one or more fence connection arm 109 to secure main fence 106 into an orthogonal position relative to tailgate inside wall 103, representing another example embodiment of the present invention. In FIG. 9A, tailgate 101 is in a closed position wherein tailgate top edge 104 is substantially horizonal or planar to the bottom surface of vehicle bed 102. In FIG. 8B, tailgate 101 has been articulated about the axis of fence hinge 108 to an open position where tailgate inside wall 103 may be substantially planar with the bottom surface of vehicle bed 102. Also shown in this example embodiment, fence top edge 123 aligns with a stationary surface of tailgate top edge 104 that is affixed to tailgate 101. Fence top edge 123 may be substantially coincident with tailgate top edge 104 on one side (as shown on towards the outside wall of tailgate 101) and may cover an inset recess in tailgate inside wall 103. FIG. 9C depicts main fence 106 extended out of tailgate cavity 122 so that fence hinge 108 is beyond an edge on tailgate inside wall 103 so that main fence 106 can freely rotate about fence hinge 108 without interference to tailgate inside wall 103. In FIG. 9D, one or more fence connection arms 109 may be stowed or inset into tailgate inside wall 103 or attached to tailgate side edges 105 and configured to articulate up about a pivot point near connection arm first end 110. A locking feature located at connection arm second end 111 may be configured to releasable lock to main fence 106 in order to prevent main fence 106 from readily rotating about fence hinge 108, or from readily moving in any direction. In other example embodiments, fence connection arm 109 may be pivotally attached to main fence 106, with a releasable lock feature located at connection arm first end 110 and configured to engage with an aperture, flange, clasp, hook, or other suitable mechanism located on tailgate inside wall 103, tailgate side edge 105, vehicle bed 102, or the side of vehicle 100. In some example embodiments, fence connection arm 109 may fold to nest within fence wall 107. Fence connection arm 109 may be a hollow tube, solid bar, chain, cable, rope, telescoping tube, or other suitable geometry.

In FIG. 9E, the one or more fence connection arm 109 are releasably locked to main fence 106 such that main fence 106 remains substantially stationary to tailgate 101.

FIGS. 10A through 10K depict isometric views of an alternative embodiment of main fence 106 in various stages between a stowed state and a deployed state, representing another example embodiment of the present invention. In FIG. 10A, tailgate 101 has a similar form as depicted in FIG. 1, however a plurality of ribs or indentations may be disposed throughout the tailgate inside wall 103 and configured to increase rigidity of tailgate inside wall 103. Fence latch 128 may releasably lock main fence 106 into tailgate cavity 122 until fence latch 128 is engaged to unlock main fence 106 and allow it to traverse out of tailgate cavity 122. Fence latch 128 may be disposed on fence top edge 123, or it may be on another surface of main fence 106, on tailgate inside wall 103, one or more tailgate side edge 105, or tailgate outside wall 124. Fence latch 128 may the mechanically operated, such as by hand, or it may also or only be electronically operated, such as with an electric solenoid.

FIGS. 10B and 10C depict an isometric and top-down view of tailgate 101 with main fence 106 now traversed out of tailgate cavity 122. In some example embodiments including those previously described, one or more ribs, ridges, bumps, tapers, flanges, clasps, cams, or other mechanisms may be used in the interaction of fence slide car 113 and fence slide track 114 in order to secure main fence 106 from readily traversing back into tailgate cavity 122. As an example, a slight increase in traverse force may be required to surpass the holding mechanism when traversing main fence 106 out of tailgate cavity 122, which in turn may require an equal or different force to surpass the holding mechanism again when traversing main fence 106 back into tailgate cavity 122. This holding mechanism may be engaged near the distal end of traversal length of main fence 106.

As depicted in FIGS. 10B and 10C, one or more side fence recesses 118 may be disposed on a top surface of main fence 106. One or more side fences 117 may be positioned within a respective one or more side fence recesses 118 and positioned so side fence end edges 131 may be coincident or inboard of fence side edges 130. The edge of side fence 117 opposite of side fence end edge 131 may be underneath a flange or the top surface of main fence 106 to substantially prevent side fence 117 from rotating about side fence axis 120. In some cases, a clasp, rotatable flange, buckle, fastener, latch, or other feature disposed on main fence 106 or on side fence 117 may be used to secure side fence 117 from rotating about side fence axis 120 and/or from traversing laterally along the length of main fence 106.

In some example embodiments, including those described in FIG. 1 and FIGS. 6, one or more fence apertures 129 may be disposed through main fence 106 with an open end nearest tailgate 101. Fence aperture 129 may be configured to allow a respective one or more additional fence slide tracks 114 and fence slide cars 113 to traverse into fence aperture 129 when main fence 106 is traversed inside tailgate cavity 122. In the example depicted, fence aperture 129 is mid-span of main fence 106, and a third fence slide track 114 bifurcates tailgate cavity 122. In some examples, the third or any additional fence slide track 114 may be configured to provide structural support for tailgate inside wall 103. In other example embodiments not shown, tailgate cavity 122 may be configured as a single cavity as depicted in FIG. 1, and one or more bearing surfaces may be disposed on fence wall 107 that may be configured to provide structural support to tailgate inside wall 103 and in some cases tailgate outside wall 124. In this example, fence aperture 129 may not be present. The bearing surfaces may be a low-friction material, such as nylon or another material, or maybe a low-friction mechanism, such as one or more wheels or ball bearings. In other example embodiments, a wall may bifurcate tailgate cavity 122 and may be configured to provide structural support to tailgate inside wall 103 and in some cases tailgate outside wall 124. Two fence slide track 114 may be configured on either side of the wall, or may themselves constitute the wall, with a respective two fence slide cars 113 engaged with each fence slide track 114 and connected to main fence 106. In this way, main fence 106 may be connected to tailgate 101 with four sets of fence slide cars 113 and fence slide tracks 114: one set at either distal end of main fence 106 or another two sets at a mid-plane of main fence 106.

FIGS. 10D and 10E depict a potential next step in the deployment process of main fence 106, where one or more side fences 117 are traversed laterally along the length of main fence 106 in opposing directions, representing one example embodiment of the present invention. In this example, side fence end edges 131 and side fence axis 120 are now more closely aligned with tailgate side edges 105. A far end of side fence 117 may be unobstructed from a retaining flange disposed on main fence 106 in order to allow side fence 117 to rotate around side fence axis 120. One or more side fence slide cars 132 may be slidably engaged with an inside groove, track, slot, aperture, or other feature disposed on one or more inside surfaces of side fence recesses 118. Side fence slide cars 132 may have limited length of lateral travel, such that side fence end edges 131 may be prevented from traversing beyond tailgate side edges 105, or so that side fence 117 is positioned coincident or close to tailgate side edge 105 when side fence 117 is deployed as shown in FIGS. 10H through 10J.

FIGS. 10F and 10G depict potential next steps, either which could occur as a next step. FIG. 10F depicts two side fences 117 now rotated about their respective side fence axis 120 into a semi or fully deployed position. In some cases, a fully deployed position would substantially position side fence 117 orthogonal to main fence 106. FIG. 10G depicts main fence 106 articulating about fence hinges 108 to an obtuse angle with tailgate inside wall 103. Fence lock flange 119 may be substantially aligned with fence lock 115 in this position.

FIGS. 10H, 10I, and 10J depict a fully deployed state of main fence 106, wherein one or more fence lock flanges 119 are releasably locked with a respective one or more fence locks 115. FIG. 10H is an isometric view of the present invention, FIG. 10I is a top-down view, and FIG. 10K is an end view, as if looking towards vehicle 100. As depicted in FIG. 10I, side fence 117 is orthogonal to main fence 106, and main fence 106 is orthogonal to tailgate inside wall 103. It is anticipated in other configurations not shown that one or more side fences 117 may be positioned in an obtuse angle to main fence 106. Also visible is the side fence slide cars 132 extended beyond the side edges of main fence 106. In some cases, a clasp, bump, lock, semi-locking mechanism, latch, or other mechanism may be used to prevent side fence slide cars 132 from readily traversing back into main fence 106 when tailgate 101 and main fence 106 are in a deployed state. In other example embodiments, side fence 117 may be configured to prevent side fence slide car 132 from traversing back into main fence 106 when side fence 117 is positioned in a deployed state, such as when side fence 117 is positioned substantially orthogonal to main fence 106. In this example, when side fence 117 is rotated about side fence axis 120 to a substantially parallel position with main fence 106, then side fence slide car 132 may be released to readily traverse back into main fence 106.

FIG. 10J depicts end view of tailgate 101, with a clear depiction of a plurality of fence slide cars 113 arranged in tailgate cavity 122. One or more fence illumination devices 127 may be disposed on a back surface of main fence 106 and be synchronized to illuminate with the brake lights or reverse lights of vehicle 100.

FIG. 10K depicts a close-up view of FIG. 10D showing one side of main fence 106, representing one example embodiment of the present invention.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

What is claimed is:

1. A vehicle tailgate assembly comprising:
a tailgate that includes:
an inside wall,
a top edge orthogonal to the inside wall, and
a cavity having an opening in the top edge; and
a fence mounted to the tailgate in a slidable and pivotal manner between a stowed state and a deployed state, wherein the fence resides within the cavity in the stowed state, and resides outside the cavity orthogonal to the inside wall in the deployed state, and wherein the fence is configured to be locked to the tailgate by a fence lock when the fence in the deployed state.

2. The assembly of claim 1, wherein the fence includes a main fence and one or more side fences, wherein each of the side fences is pivotally mounted to a respective end of the main fence.

3. The assembly of claim 2, wherein the main fence includes a recess for receiving each of the side fences in a nested configuration.

4. The assembly of claim 2, wherein the fence lock is configured to releasably lock each of the side fences to the tailgate so as to prevent rotation of the main fence relative to the tailgate.

5. The assembly of claim 2, wherein each of the side fences form an obtuse angle with the main fence when the main fence is releasably locked to the tailgate.

6. The assembly of claim 1, wherein the cavity is at least partially bifurcated by a central support.

7. The assembly of claim 1, wherein the fence has at least one aperture configured to fit around a central support so as to permit sliding movement of the fence between the stowed state and the deployed state.

8. The assembly of claim 1, wherein the fence is mounted to the tailgate by a fence hinge that resides outside the cavity when the fence is in the deployed state.

9. The assembly of claim 1, further comprising a slide track on each side of the cavity, wherein a slide car of the fence engages with the slide track.

10. The assembly of claim 9, wherein the fence is mounted to the slide track or to the slide car.

11. The assembly of claim 9, further comprising a slot in the fence and a pin on the slide car, the slot and the pin arranged such that when the fence is in the deployed state, the pin is movable vertically within the slot to a lowered position in which the fence engages a surface on the top edge of the tailgate below the opening, thereby releasably locking the fence to the tailgate.

12. The assembly of claim 1, further comprising a latch configured to releasably lock the fence inside the cavity when the fence is in the stowed state.

13. A vehicle tailgate assembly, comprising:
a tailgate that includes:
an inside wall,
a top edge orthogonal to the inside wall, and
a cavity having an opening in the top edge;
a main fence mounted to the tailgate in a slidable and pivotal manner between a stowed state and a deployed state, wherein the main fence resides within the cavity in the stowed state and resides outside the cavity orthogonal to the inside wall in the deployed state, and wherein the main fence is locked to the tailgate by a fence lock in the deployed state;
means for releasably locking the main fence inside the cavity when in the stowed state; and
at least one side fence pivotally mounted to the main fence and configured to releasably lock the at least one side fence to the tailgate when the main fence is in the deployed state.

14. The assembly of claim 13, wherein the at least one side fence is pivotally mounted to the main fence to pivot about a side fence axis to a position orthogonal to the main fence.

15. The assembly of claim 13, wherein the at least one side fence is mounted to at least one slide car so as to permit lateral movement of the at least one side fence relative to the main fence.

16. The assembly of claim 13, wherein the main fence has a recess to receive each of the at least one side fence in a nested configuration when the main fence is in the stowed state.

17. The assembly of claim 13, wherein the cavity is at least partially bifurcated by a central support, and the main fence includes an aperture configured to fit around the central support to permit sliding movement of the main fence between the stowed and deployed states.

18. The assembly of claim 13, wherein the main fence includes bearing surfaces configured to provide structural support to the inside wall of the tailgate.

19. The assembly of claim 13, further comprising a slide track on each of two opposing sides of the cavity, and a slide car on the main fence, the slide car configured to engage with the slide track.

20. The assembly of claim 19, further comprising a slot in the main fence and a pin on the slide car, the slot and the pin arranged such that when the main fence is in the deployed state, the pin is movable vertically within the slot to a lowered position in which the main fence engages a surface on the top edge below the opening, thereby releasably locking the fence to the tailgate.

21. The assembly of claim 13, wherein the main fence is pivotal about a main fence hinge which resides outside the cavity when the main fence is in the deployed state.

22. The vehicle tailgate assembly of claim 13, further comprising a latch configured to releasably lock the main fence inside the cavity when the main fence is in the stowed state.

23. A method of loading cargo onto a vehicle bed with a tailgate, the method comprising:
lowering the tailgate to a horizontal position, wherein the tailgate includes an inside surface, a cavity, a main fence within the cavity, and at least one side fence rotatably connected to the main fence;
loading the cargo into the vehicle bed such that the cargo extends onto the inside surface of the tailgate;
sliding the main fence out of the cavity;
rotating the at least one side fence to an at least orthogonal position relative to the main fence;
pivoting the main fence about a main fence hinge axis to an orthogonal position relative to the inside surface of the tailgate; and
locking the at least one side fence to the tailgate, wherein the at least one side fence is releasably locked to the tailgate.

24. The method of claim 23, wherein rotating the at least one side fence includes releasing each of the at least one side fence from a nested configuration within a recess of the main fence.

25. The method of claim 23, wherein releasably locking each side fence to the tailgate prevents the main fence from rotating about the main fence hinge.

26. The method of claim 23, wherein the main fence has at least one aperture.

27. The method of claim 23, wherein the cavity is at least partially bifurcated by a central support, and the main fence comprises an aperture configured to fit around the central support and to thereby permit stowing the main fence inside the cavity.

28. The method of claim 25, wherein sliding the main fence out of the cavity includes sliding each slide car along a slide track on each opposing side of the cavity, and wherein the fence is mounted to the slide car.

29. The method of claim 23, wherein sliding the main fence out of the cavity includes sliding the main fence through a cavity opening until the main fence hinge axis is outside the cavity so as to allow the main fence to pivot to the orthogonal position relative to the inside surface of the tailgate.

30. The method of claim 29, wherein pivoting the main fence about the main fence hinge axis includes lowering the main fence over the cavity opening, wherein the main fence hinge has a slot therein and a slide car has a pin thereon, the slot and pin arranged such that when the main fence is orthogonal to the inside surface of the tailgate, the pin is movable vertically within the slot.

31. The method of claim 23, wherein loading the cargo into the vehicle bed includes loading without interference with the main fence and the side fence, and wherein the cargo is at least 48 inches by at least 96 inches, and resides within a combined dimensions of the vehicle bed and the inside surface of the tailgate.
